(19) United States
(12) Patent Application Publication
(10) Pub. No.: US 2009/0065606 A1
(43) Pub. Date: Mar. 12, 2009

(54) Remote-Controlled Electric Sprinkler

(76) Inventors: Feng-Nien Lee, Shenzhen City (CN); Kuai-Wuu Sung, Shenzhen City (CN)

Correspondence Address: Dr. BANGER SHIA, 102 Lindencrest Ct., Sugar Land, TX, 77479-5201, US

(21) Appl. No.: 11/853,015

(22) Filed: Sep. 10, 2007

(51) Int. Cl. A01G 27/00

(52) U.S. Cl. 239/67; 239/70

(57) ABSTRACT

A remote-controlled electric sprinkler comprises: a control circuit, a motor, a sprinkler head, and a sensor. The control circuit controls the motor for rotating the sprinkler head and making the sprinkler head sprinkle water in a rotated pattern. The sensor senses and adjusts the rotation angle of the sprinkler head, so as to control the water sprinkling range and direction. In addition, the control circuit can also adjust the water sprinkling distance and amount of water of water sprinkled out of the sprinkler head to meet the environmental requirements.

### BACKGROUND OF THE INVENTION

1. Field of the Invention

The present invention relates to a sprinkler, and more particular to a remote-controlled electric sprinkler, which is controllable in terms of water-sprinkling direction, range, distance, and amount of water to be sprinkled.

2. Description of the Prior Art

The design of conventional sprinklers is mostly focused on structure to allow the water flowing through the pipeline of the sprinkler to rotate the sprinkler head, thus achieving a rotary spray pattern.

However, such a sprinkler has a problem that is still unsolvable today, that is, the water sprinkling angle or range is fixed, and the water must be sprinkled in a circle. Therefore when the sprinkler is set in the corner of the lawn of a park and rotates to a specific angle, the water will be sprinkled onto the footpath, this will not only make the road wet and slippery, waste the water, and the sprinkled water will probably wet the passersby. It is apparent that the conventional sprinkler will have the above problems when it is set in a place adjacent to a road, such as the park.

If this sprinkler is set in the corner of the lawn of a home, the water will probably sprinkled onto the fencing which is usually made of wood, and the long period of wet condition will cause damage or decay to the wood fencing. Or, different plants in the same water sprinkling range need different amounts of water, therefore, sprinkling with the same amount of water will probably cause some plants to wither away because of shortage of water or cause some plants to decay away due to excessive water.

Although some conventional sprinklers can be adjusted in terms of amount of water to be sprinkled and sprinkling range, however, they can only be adjusted manually, and it would take a lot of time and energy to adjust all the sprinklers.

To solve the above problems, the inventor of the present invention, based on many years of experiences in the sprinkler researching field, has invented a remote-controlled electric sprinkler which is controllable in terms of water-sprinkling direction, range, distance, and amount of water.

### SUMMARY OF THE INVENTION

The primary objective of the present invention is to provide a remote-controlled electric sprinkler, which is controllable in terms of water-sprinkling direction and range to meet the environmental requirements.

The secondary objective of the present invention is to provide a remote-controlled electric sprinkler, which is controllable in terms of distance and amount of water to be sprinkled.

To achieve the first objective, the remote-controlled electric sprinkler is provided with a control circuit for rotating the sprinkler head, a power source supplying power to the control circuit, and a sensor for sensing the rotation angle of the sprinkler head. The control circuit can figure out the rotation angle of the sprinkler head through the sensor so as to stop the motor or instruct it to rotate in a reverse direction when the sprinkler head rotates to a predetermined angle. And thus, the sprinkling angle can be controlled. And a remote control is used to control the water sprinkling range and direction.

To achieve the second objective, the remote-controlled electric sprinkler is further provided with an electric valve (also called electromagnetic valve), which is disposed between the sprinkler head and the water source and is controlled by the control circuit. The control circuit can control the amount of water of water sprinkled by controlling the open or close degree of the electric valve (also called electromagnetic valve).

To control the water sprinkling distance, the remote-controlled electric sprinkler can also be controlled such that the water is sprinkled via the selected water-discharge apertures with desired diameters, when the sprinkler head rotates to the predetermined angle, and thus the water sprinkling distance can be controlled.

In addition, the remote-controlled electric sprinkler can also be provided with a solar panel, which is a battery connected to the control circuit for converting solar energy into electric energy, and then the electric energy is transmitted to and stored in the battery via the control circuit.

The remote-controlled electric sprinkler can also be provided with a remote control connected to the control circuit for controlling the operation mode of the remote-controlled electric sprinkle.

### BRIEF DESCRIPTION OF THE DRAWINGS

FIG. 1 is a perspective view of a remote-controlled electric sprinkler in accordance with the present invention; and

FIG. 2 is a circuit diagram of the remote-controlled electric sprinkler in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

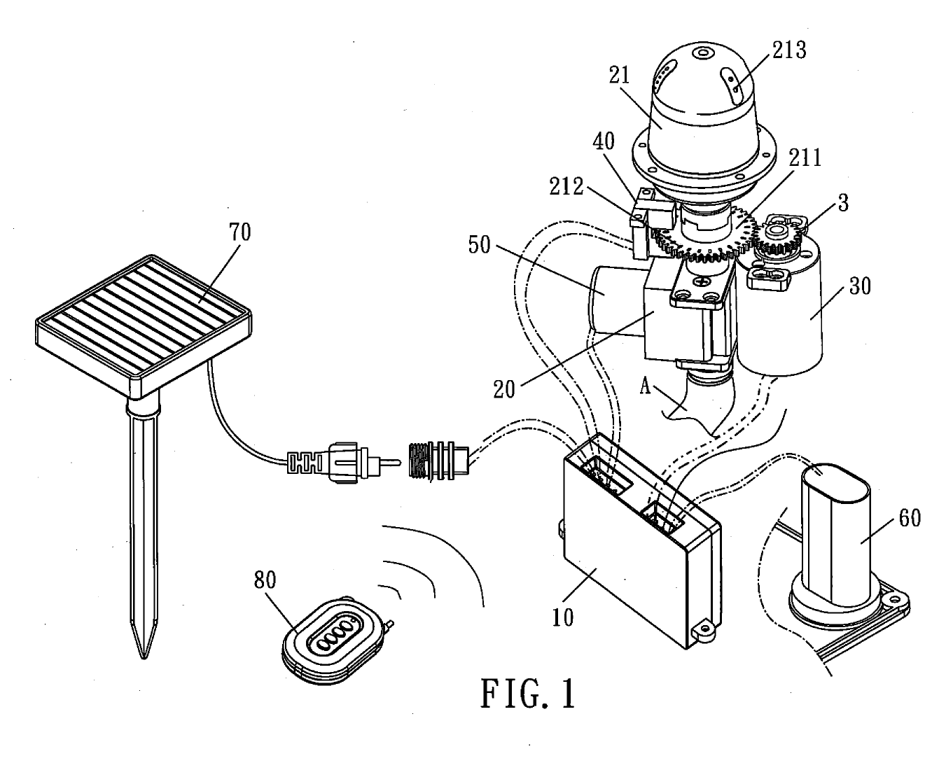

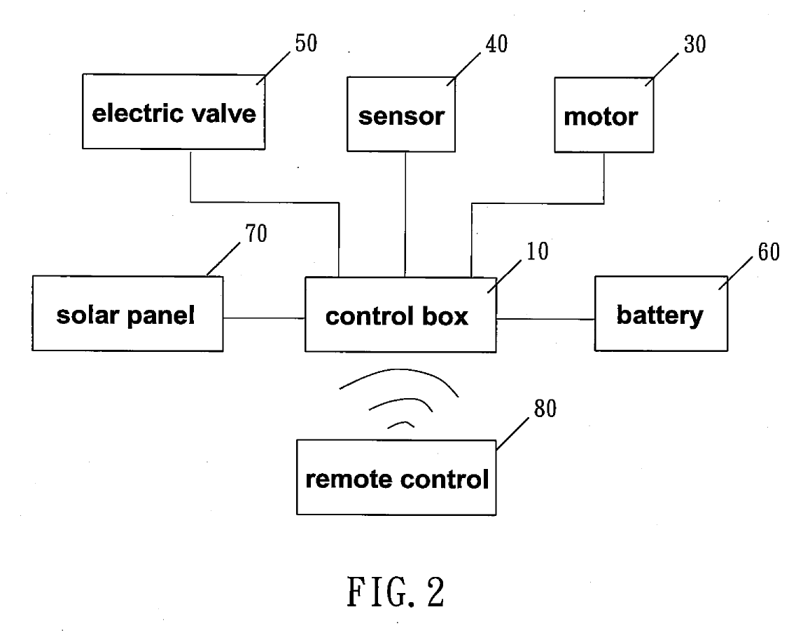

Referring to FIGS. 1 and 2, a remote-controlled electric sprinkler in accordance with the present invention comprises: a control box 10, a base 20, a motor 30, a sensor 40, an electric valve (also called electromagnetic valve) 50, a battery 60, a solar panel 70, and a remote control 80.

The control box 10 contains a control circuit (not shown).

The base 20 has one end connected to a water pipe A and has the other end pivotally connected with a sprinkler head 21 which is rotatable relative to the base 20. The sprinkler head 21 includes a driven member 211 in the form of a gear and a plurality of sensing elements 212 formed on the driven member 211 and equidistantly arranged around the rotary shaft of the sprinkler head 21. One end of the sprinkler 21 is connected to the water pipe A, and the other end is formed with a plurality of water-discharge apertures 213 with different diameters.

The motor 30 is connected to and controlled by the control circuit of the control box 10. A transmission member 31 is mounted on the rotary shaft of the motor 30 and is to be engaged with the driven member 211 of the sprinkler head 21, so that the motor 30 drives the transmission member 31 to rotate, and then the transmission member 31 drives the transmission member 211 to rotate the sprinkler head 21. In this embodiment, the transmission member 31 is a gear for meshing with the driven member 211.

The sensor 40 is connected to the control circuit of the control box 10 for sensing the sensing elements 212 and transmitting the sensing result to the control circuit.

The electric valve(also called electromagnetic valve) 50 is connected to the control circuit of the control box 10 and controlled by it. The electric valve(also called electromagnetic valve) 50 is disposed on the base 20 for closing the passage between the water pipe A and the sprinkler head 21. The control circuit controls the open and close of the electric valve(also called electromagnetic valve) 50 so as to control the connection between the water pipe A and the sprinkler head 21, and the control circuit can further control the open/close degree of the electric valve(also called electromagnetic valve) 50.

The battery 60 is connected to the control circuit of the control box 10 and supplies power to the control circuit and the respective components.

The solar panel 70 is connected to the control circuit of the control box 10 for converting solar energy into electric energy, and then the electric energy is transmitted to and stored in the battery 60 via the control circuit.

The remote control 80 is connected to the control circuit of the control box 10, so that the remote control 80 can control the control circuit and the operation of the respective components.

During sprinkling, the control circuit controls the operation of the motor 30 such that the transmission member 31 of the motor 30 drives the driven member 211 to rotate sprinkler head 21. And then the control circuit controls the open or close of the electric valve(also called electromagnetic valve) 50 to allow water to flow to the sprinkler head 21 through the water pipe A, so that water can be sprinkled out of the sprinkler 21 via the water-discharge apertures 213. Meanwhile, the sprinkler head 21 can sprinkle water in a rotary pattern since the motor 30 rotates it.

Further, since the sensor 40 senses the sensing elements 212 of the driven member 211 and transmits the sensed data to the control circuit, the control circuit can figure out the rotation angle of the sprinkler head 21 based on the total data of the sensing elements 212. If a limitation of the rotation angle of the sprinkler head 21 is preset in the control circuit, the control circuit will stop the motor 30 or instruct it to rotate in a reverse direction when the sprinkler head 21 rotates to the predetermined angle, so that the water sprinkling angle, range and direction of the sprinkler can be controlled.

When the sprinkler head 21 rotates to the predetermined angle, the control circuit can also control such that the water can be sprinkled via the selected water-discharge apertures 213 with desired diameters. With the same amount of water or density, the water flowing through the water-discharge apertures 213 with smaller diameter can be sprinkled further than the water flowing through the water-discharge apertures 213 with greater diameter, and thus the sprinkling distance can be controlled.

The control circuit can also control the open and close degree of the electric valve(also called electromagnetic valve) 50, when the electric valve(or electromagnetic valve) 50 is opened to a greater degree, the amount of water of water flowing through the water-discharge apertures 213 is relatively large, and the amount of water of the sprinkled water is also comparatively large. Similarly, when the electric valve(also called electromagnetic valve) 50 is opened to a smaller degree, the amount of water of water flowing through the water-discharge apertures 213 is relatively small, and the amount of water of the sprinkled water is also comparatively small. In this way, the amount of water of water sprinkled out of the remote-controlled electric sprinkler can be controlled.

It is apparent from above that the remote-controlled electric sprinkler can adjust the water sprinkling range and direction by controlling the rotation angle of the sprinkler head 20, and can adjust the water sprinkling distance by sprinkling the water out of the different water-discharge apertures 213 of different diameters, and can also adjust the amount of water of water sprinkled by controlling the open or close degree of the electric valve(also called electromagnetic valve) 50. Thus, the water sprinkling range, direction, distance and amount of water of water sprinkled can be controlled to meet the environmental requirements.

In addition, after all the parameters are set in the control circuit, the sprinkling modes of the remote-controlled sprinkler can be adjusted automatically. And the remote control 80 can control the operation of the remote-controlled sprinkler directly by controlling the control circuit.

While we have shown and described various embodiments in accordance with the present invention, it is clear to those skilled in the art that further embodiments may be made without departing from the scope of the present invention.

What is claimed is:

1. A remote-controlled electric sprinkler comprising:
a control circuit;
a power source connected to the control circuit for supplying power to it;
a motor connected to and controlled by the control circuit; and
a base pivotally provided with a sprinkler head and connected to a water pipe, the sprinkler head being connected to the water pipe and rotated by the motor, a plurality of water-discharge apertures being defined in the sprinkler head.

2. The remote-controlled electric sprinkler as claimed in claim 1, wherein the water-discharge apertures have different diameters.

3. The remote-controlled electric sprinkler as claimed in claim 1, wherein the sprinkler head includes a driven member for connecting with a transmission member on a rotary shaft of the motor.

4. The remote-controlled electric sprinkler as claimed in claim 3, wherein the driven member and the transmission member are gears for meshing each other.

5. The remote-controlled electric sprinkler as claimed in claim 3, wherein a plurality of sensing elements is disposed on the driven member and located around a rotary shaft of the sprinkler head.

6. The remote-controlled electric sprinkler as claimed in claim 5 further comprising a sensor to be connected to the control circuit for sensing the sensing elements.

7. The remote-controlled electric sprinkler as claimed in claim 1 further comprising an electric valve(also called electromagnetic valve) disposed between the water pipe and the sprinkler head, and the electric valve(also called electromagnetic valve) is connected to and controlled by the control circuit.

8. The remote-controlled electric sprinkler as claimed in claim 1 further comprising a solar panel connected to the control circuit for converting solar energy into electric energy, and then the electric energy is transmitted to and stored in the battery via the control circuit.

9. The remote-controlled electric sprinkler as claimed in claim 1 further comprising a remote control connected to the control circuit.

10. A remote-controlled electric sprinkler comprising:
a control circuit;
a power source connected to the control circuit for supplying power to it;
a motor connected to and controlled by the control circuit, and a transmission member being mounted on a rotary shaft of the motor; and
a base pivotally provided with a sprinkler head and connected to a water pipe, the sprinkler head being connected to the water pipe and rotated by the motor, a driven member being mounted on the sprinkler head for meshing with the transmission member, a plurality of water-discharge apertures being defined in the sprinkler head.

11. The remote-controlled electric sprinkler as claimed in claim 10, wherein the driven member and the transmission member are gears for meshing each other.

12. The remote-controlled electric sprinkler as claimed in claim 10, wherein a plurality of sensing elements is disposed on the driven member and located around a rotary shaft of the sprinkler head.

13. The remote-controlled electric sprinkler as claimed in claim 12 further comprising a sensor to be connected to the control circuit for sensing the sensing elements.

14. The remote-controlled electric sprinkler as claimed in claim 10 further comprising an electric valve (also called electromagnetic valve) disposed between the water pipe and the sprinkler head, and the electric valve(also called electromagnetic valve) is connected to and controlled by the control circuit.

15. The remote-controlled electric sprinkler as claimed in claim 10 further comprising a solar panel connected to the control circuit for converting solar energy into electric energy, and then the electric energy is transmitted to and stored in the battery via the control circuit.

16. The remote-controlled electric sprinkler as claimed in claim 10 further comprising a remote control connected to the control circuit.

17. A remote-controlled electric sprinkler comprising:
a control circuit;
a power source connected to the control circuit for supplying power to it;
a motor connected to and controlled by the control circuit, and a transmission member being mounted on a rotary shaft of the motor;
a base pivotally provided with a sprinkler head and connected to a water pipe, the sprinkler head being connected to the water pipe and rotated by the motor, a driven member being mounted on the sprinkler head for connected to the transmission member, a plurality of sensing elements arranged on the driven member, a plurality of water-discharge apertures being defined in the sprinkler head and located around a rotary shaft of the sprinkler head; and
a sensor connected to the control circuit for sensing the sensing elements.

18. The remote-controlled electric sprinkler as claimed in claim 17 further comprising an electric valve(also called electromagnetic valve) disposed between the water pipe and the sprinkler head, and the electric valve(also called electromagnetic valve) is connected to and controlled by the control circuit.

19. The remote-controlled electric sprinkler as claimed in claim 17 further comprising a solar panel connected to the control circuit for converting solar energy into electric energy, and then the electric energy is transmitted to and stored in the battery via the control circuit.

20. The remote-controlled electric sprinkler as claimed in claim 17 further comprising a remote control connected to the control circuit.
